(19) United States
(12) Patent Application Publication
(10) Pub. No.: US 2016/0013681 A1
(43) Pub. Date: Jan. 14, 2016

(54) MULTI-FUNCTION ATTACHMENT

(71) Applicants: CHAMP TECH OPTICAL (FOSHAN) CORPORATION, Foshan (CN); Foxconn Technology Co., Ltd., New Taipei (TW)

(72) Inventors: LONG-QING LIANG, Foshan (CN); DI-QIONG ZHAO, Foshan (CN); QIU-RI ZHANG, New Taipei (TW); CHIH-FENG HU, New Taipei (TW); YUNG-PING LIN, New Taipei (TW)

(21) Appl. No.: 14/678,586

(22) Filed: Apr. 3, 2015

(30) Foreign Application Priority Data
Jul. 11, 2014 (CN) 201410329908.7

(51) Int. Cl. H02J 7/02; H02J 7/00; H04B 5/00

(52) U.S. Cl. CPC H02J 7/025; H04B 5/0037; H02J 7/0042

(57) ABSTRACT

A multi-function attachment includes a battery module including a frame, a circuit and an energy storage received in the frame; and a wireless charging module located at a side of the energy storage and coupled with the circuit, a space is defined in the frame to received the energy and the circuit therein, a window is defined on a side of the frame and an opening is defined on a top end of the frame, While the energy storage is received in the space of the frame, a side of the energy storage exposed toward the window and the edge of the window form a groove, and the wireless charging module is received in the groove and is coupled to the circuit.

### CROSS-REFERENCE TO RELATED APPLICATIONS

This application claims priority to Chinese Patent Application No. 201410329908.7 filed on Jul. 11, 2014, the contents of which are incorporated by reference herein.

### FIELD

The subject matter herein generally relates to a multi-function attachment having a function of near field communication (NFC) and wireless charging.

### BACKGROUND

An electronic device having a function of wireless charging and near field communication (NFC) needs to configure to a wireless charging module and NFC module. However, the wireless charging module and the NFC module are mounted in the electronic device and are coupled with the circuit of the electronic device. The wireless charging module receives outside of magnetic signals and converts the magnetic signals to induced currents and conducts the induced currents to a battery that is received in the electronic device to charge the battery.

### BRIEF DESCRIPTION OF THE DRAWINGS

Implementations of the present technology will now be described, by way of example only, with reference to the attached figures.

FIG. 1 is partially exploded view of a multi-function attachment.

FIG. 2 is an exploded view of the multi-function attachment of FIG. 1.

FIG. 3 is an exploded view similar to of the multi-function of FIG. 2 but shown from another angle.

### DETAILED DESCRIPTION OF EMBODIMENTS

It will be appreciated that for simplicity and clarity of illustration, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure. The description is not to be considered as limiting the scope of the embodiments described herein.

Several definitions that apply throughout this disclosure will now be presented. The term “comprising” means “including, but not necessarily limited to”; it specifically indicates open-ended inclusion or membership in a so-described combination, group, series and the like. The term “coupled” is defined as connected, whether directly or indirectly through intervening components, and is not necessarily limited to physical connections. The connection can be such that the objects are permanently connected or releasably connected. The term “electronically coupled” can include any coupling that is via a wired or wireless connection. The electronic coupling can be through one or more components or it can include a direct connection between the described components.

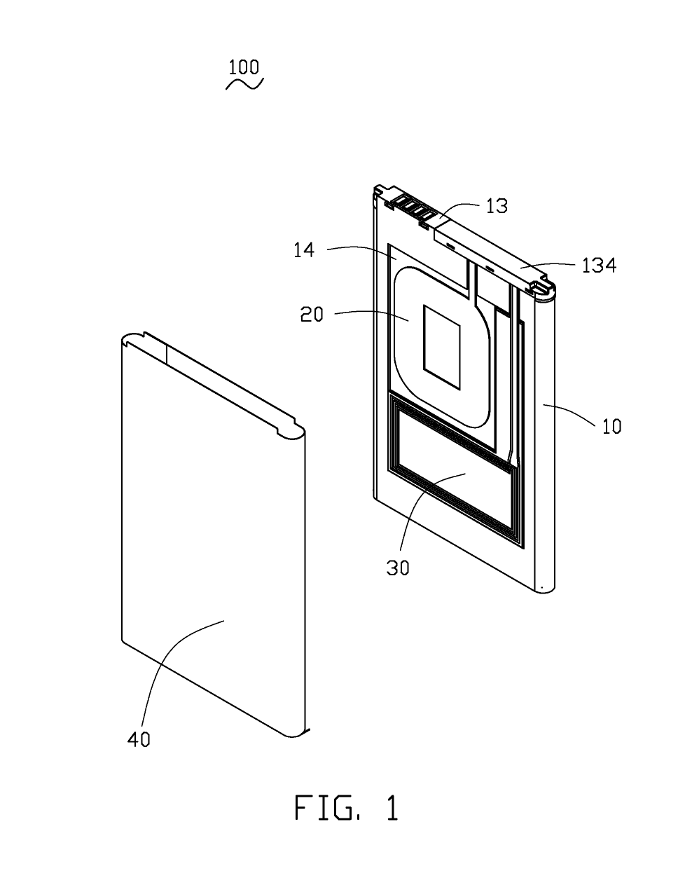

Referring to FIG. 1, a multi-function attachment 100 includes a battery module 10, a circuit 13, a wireless charging module 20, a NFC module 30 and a shell 40. The circuit 13 is mounted on a top end of the battery module 10. The wireless charging module 20 and the NFC module 30 are located at a side of the battery module 10. The shell 40 includes the outmost surface of the battery module 10 and encloses the battery module 10, the wireless module 20 and the NFC module 30 therein.

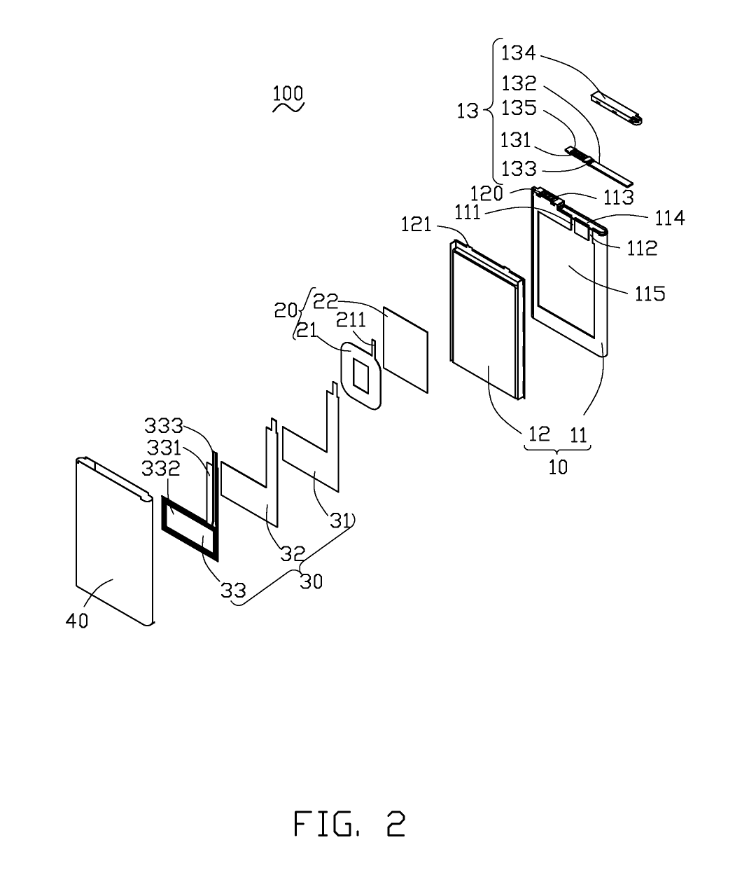

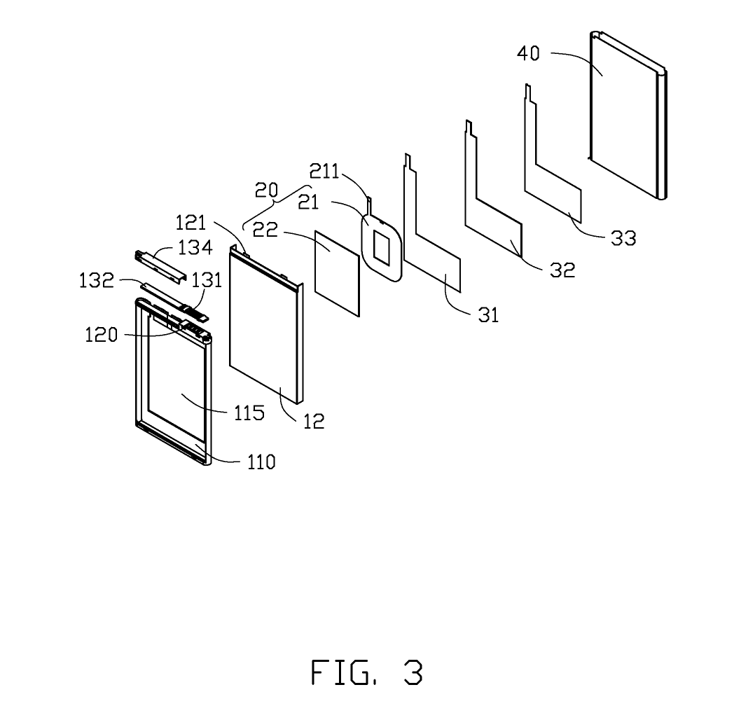

Referring to FIGS. 2-3, the battery module 10 includes a frame 11 and an energy storage 12 received in the frame 11. The circuit 13 is received in a top end of the frame 11 and coupled with the wireless charging module 20 and the NFC module 30.

In this embodiment, the energy storage 12 is rectangular. A pair of extending portions 121 is formed on a top end of the energy storage 12. The energy storage 11 electrically connects to the circuit 13 by the extending portion 121.

The circuit 13 is located at a top end of the energy storage 12. The circuit 13 includes a base 131, a printed circuit board 132, multiple connecting portions 133 and a covering portion 134. The connecting portion 133 is coupled with the base 131 and the printed circuit board 132. The covering portion 134 is cooperated with the printed circuit board 132 and covers the printed circuit board 132 therein. A plurality of contacting portion 135 is formed on a side of the base 131. The energy storage 12 output the energy through the contacting portion 135 to the electronic device.

The frame 11 is cooperated with the energy storage 12 and the circuit 13. A space 110 is defined in the frame 11 to receive the energy 12 and the circuit 13 therein. A window 115 is defined on a side of the frame 11, and an opening 114 is defined on an end of the frame 11. The opening 114 and the window 115 are through the space 110 of the frame 11. While the energy storage 12 is received in the space 110 of the frame 11, a side of the energy storage 12 exposed toward the window 115 and the edge of the window 115 form a groove 14. The groove 14 can receive the wireless charging module 20 and the NFC module 30 therein.

A plurality of blocks 113 is formed on part of the opening 114, and multiple gaps 120 are defined between every block 113. The base 131 and the connecting portion 133 are accordingly mounted in the plurality of blocks 113, and the contacting portions 135 of the base 131 are exposed out of the gaps 120 to couple to electronic device. Another part of the opening 114 is corresponding to the covering portion 134 to enclose the printed circuit board 132 therein.

A first channel 111 and a second channel 112 are formed on the frame 11. The first channel 111 and a second channel 112 are defined between the opening 114 and the window 115. The first channel 111 is a road of the wireless chaging module 20 to connect to the circuit 13, and the second channel 112 is a road of the NFC module 30 to connect to the circuit 13.

The wireless charging module 20 includes a receiving coil 21 and a spacer 22. The wireless charging module 20 can be fixed to a side of the energy storage 12 by gules or by a way of magnetic adsorption. The receiving coil 21 is fixed on a side of the spacer 22 and senses outside of magnetic signals to induced current. The spacer 22 is located between the receiving coil 21 and the energy storage 12 to optimize magnetic signals received by the receiving coil 21. The receiving coil 21 further includes a coupling arm 211. The coupling arm 211 is extending through the first channel 111 and coupled to the printed circuit board 132. The induced current from the receiving coil 21 is conducted to the printed circuit board 132 by the arm coupling 211. In at least one embodiment, the wireless charging module 20 can includes multiple receiving coil 21 fixed on the spacer 22, and a shape of every receiving coil 21 is different.

The NFC module 30 and the wireless charging module 20 are fixed on a same side of the energy storage 12. The NFC module 30 includes a base 31, a connecting plate 32 and a receiving unit 33. The base 31 and the receiving unit 33 are respectively located at an opposite side of the connecting plate 32 and are coupled with the connecting plate 32. The receiving unit 33 includes a main portion 331, a NFC coil 332 fixed on the main portion 331, and a extending portion 333 connected with the NFC coil 332. The extending portion 333 extends through the second channel 112 and is coupled to the printed circuit board 132 to conduct the signals from the NFC coil 332 to the printed circuit board 132. The base 31 and the connecting plate 32 are corresponding to the receiving unit 33 and has a similar shape with the receiving unit 33.

The shell 40 is arranged on the outmost battery 10 to enclose the battery 10, the wireless charging module 20 and NFC module 30 therein. Both ends of the shell 40 is open, so the circuit 13 of the battery 10 is exposed.

In this disclosure, the multiple-function battery 100 has wireless charging and NFC function. The wireless charging module 20 and the NFC module 30 are arranged in the multi-function attachment. Electric signals from the wireless charging module 20 and the NFC module 30 is directly conducted to the multi-function attachment, is not through out of the circuit of the electronic device. The wireless charging module 20 and the NFC module have no interference with the circuit of the electronic device. A electronic device having the multi-function attachment can have a function of wireless charging and NFC. So the multi-function attachment 100 can have good stability and practicability

The embodiments shown and described above are only examples. Many details are often found in the art such as the other features of a multi-function attachment. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A multi-function attachment, comprising:
a battery module including a frame, a circuit and an energy storage received in the frame; and
a wireless charging module located at a side of the energy storage and coupled with the circuit;
wherein a space is defined in the frame to received the energy and the circuit therein, a window is defined on a side of the frame and an opening is defined on an top end of the frame, while the energy storage is received in the space of the frame, a side of the energy storage exposed toward the window and the edge of the window form a groove;
wherein the wireless charging module is received in the groove and is coupled to the circuit.

2. The multi-function attachment of claim 1, wherein the circuit is received in an top end of the frame and located at a top end of the energy storage.

3. The multi-function attachment of claim 1, wherein a pair of extending portions is formed on a top end of the energy storage to electrically connect to the circuit.

4. The multi-function attachment of claim 1, wherein the circuit includes a base, a printed circuit board, multiple connecting portions and a covering portion, the connecting portions is coupled with the base and the printed circuit board.

5. The multi-function attachment of claim 4, wherein the covering portion is cooperated with the printed circuit board and covers the printed circuit board therein.

6. The multi-function attachment of claim 4, wherein a plurality of contacting portions is formed on a side of the base, a plurality of blocks is formed on part of the opening and multiple gaps are defined between every block.

7. The multi-function attachment of claim 6, wherein the base and the connecting portion are accordingly mounted in the plurality of blocks, and the contacting portions of the base are exposed out of the gaps.

8. The multi-function attachment of claim 1, wherein a first channel and a second channel are formed on the frame and are through the opening and the window.

9. The multi-function attachment of claim 8, wherein the wireless charging module includes a spacer and a receiving coil fixed on a side of the spacer.

10. The multi-function attachment of claim 9, wherein the receiving coil further includes a coupling arm extending through the first channel and coupled to the printed circuit board.

11. The multi-function attachment of claim 1, wherein a NFC module is further included, the NFC module is located at a same side of the energy storage with the wireless charging module.

12. The multi-function attachment of claim 1, wherein the NFC module includes a base, a connecting plate and a receiving unit.

13. The multi-function attachment of claim 12, wherein the base and the receiving unit are respectively located at an opposite side of the connecting plate and are coupled with the connecting plate.

14. The multi-function attachment of claim 13, wherein the receiving unit includes a main portion, a NFC coil fixed on the main portion and a extending portion connected with the NFC coil.

15. The multi-function attachment of claim 14, wherein the extending portion extends through the second channel and is coupled to the printed circuit board.

16. A multi-function attachment, comprising:
a battery module including a frame, a circuit and an energy storage received in the frame;
and a wireless charging module and a NFC module located at a side of the energy storage and coupled with the circuit;
a shell configured on the outmost surface of the battery module and enclosing the battery module, the wireless charging module and the NFC module therein;
wherein a space is defined in the frame to received the energy storagy and the circuit therein, a window is defined on a side of the frame and an opening is defined on an end of the frame, a first channel and a second channel are formed on the frame and are through the opening and the window, while the energy storage is received in the space of the frame 11, a side of the energy storage exposed toward the window and the edge of the window form a groove;
wherein the wireless charging module and the NFC module are received in the groove and are coupled to the circuit.

17. The multi-function attachment of claim 16, wherein the circuit is received in a top end of the frame and located at a top end of the energy storage.

18. The multi-function attachment of claim 17, wherein a pair of extending portions is formed on the top end of the energy storage to connect to the circuit.

19. The multi-function attachment of claim 16, wherein the circuit includes a base, a printed circuit board, multiple connecting portions and a covering portion, the connecting portions is coupled with the base and the printed circuit board.

20. A multi-function attachment for an electronic device, comprising:
a battery module;
a wireless charging module;
a near field communication (NFC) module;
a connecting portion connectable to the electronic device; and
an circuit connecting the connecting portion to the battery module, wireless charging module and the NFC module;
wherein, when connected to the electronic device the multi-function attachment may, through the circuit, wirelessly charge the electronic device and provide near field communication for the electronic device.
